(19) United States
(12) Patent Application Publication
(10) Pub. No.: US 2024/0146626 A1
(43) Pub. Date: May 2, 2024

(54) INGRESS TRAFFIC CLASSIFICATION IN CONTAINER NETWORK CLUSTERS

(71) Applicant: VMware LLC, Palo Alto, CA (US)

(72) Inventors: Rostislav Mariyanov Georgiev, Sofia (BG); Meori Oransky, Ramat Gan (IL)

(21) Appl. No.: 17/975,459

(22) Filed: Oct. 27, 2022

(51) Int. Cl. H04L 43/045; H04L 41/22; H04L 45/76

(52) U.S. Cl. CPC H04L 43/045; H04L 41/22; H04L 45/76

(57) ABSTRACT

Some embodiments of the invention provide a method for identifying and generating visualizations of ingress data traffic flows to a workload cluster in a software-defined network (SDN). From multiple data traffic flows associated with a particular cluster of destination workloads in the SDN, the method identifies a set of ingress data traffic flows destined to the particular cluster of destination workloads. For each identified ingress data traffic flow, the method identifies a service from a set of services through which the ingress data traffic flow reached the particular cluster of destination workloads. The method generates a visualization for display through a user interface (UT), the visualization comprising (i) representations of each workload in the particular cluster of destination workloads, (ii) representations of the set of services through which the set of ingress data traffic flows reach the particular cluster of destination workloads, and (iii) a representation of the set of ingress data traffic flows terminating on the particular cluster of destination workloads.

### BACKGROUND

Today, containers and container networks (e.g., Kubernetes) enable organizations to deliver applications at faster speeds than ever before. However, these applications cannot be deployed at the expense of security. Adversaries can use APIs (application programming interfaces) to compromise clusters and to access sensitive data from the workloads in the clusters, either on premises or in the cloud. Without seamless integration of security at each layer throughout the development lifecycle, the deployments cannot effectively protect against attacks.

### BRIEF SUMMARY

Some embodiments of the invention provide a method for identifying and generating visualizations of ingress data traffic flows to a workload cluster in a software-defined network (SDN). The method identifies, from multiple data traffic flows (e.g., ingress data traffic flows, egress data traffic flows, and internal data traffic flows) associated with a particular cluster of destination workloads, a set of ingress data traffic flows destined to the particular cluster of destination workloads. For each identified ingress data traffic flow, the method identifies a service from a set of services (e.g., load balancer services and NodePort services) through which the ingress data traffic flow reached the particular cluster of destination workloads. The method then generates, for display through a user interface (UI), a visualization that includes representations of each workload in the particular cluster of destination workloads, representations of the set of services through which the set of ingress data traffic flows reach the particular cluster of destination workloads, and a representation of the set of ingress data traffic flows terminating on the particular cluster of destination workloads.

In some embodiments, the UI includes a set of selectable UI items for modifying the visualization and viewing data associated with the identified ingress data traffic flows. The viewable data, in some embodiments, includes both five-tuple data associated with the ingress data traffic flows, as well as contextual data associated with the ingress data traffic flows. The contextual data, in some embodiments, includes ingress service type (e.g., load balancer or NodePort), service name, service namespace, public port number, public IP (Internet protocol) address and/or domain name, service cluster IP address (i.e., an IP address associated with the set of services), workload kind, workload name, a workload namespace, and a workload port number. In some embodiments, the data also includes the transport layer protocol, the application layer protocol, and an indication of an amount of data in bytes exchanged during the ingress data traffic flow.

The data provided through the UI, in some embodiments, is based on data used to enrich network events generated for each data traffic flow associated with the particular cluster of workloads. When identifying the set of ingress data traffic flows, in some embodiments, contextual data associated with each data traffic flow is collected and added to the network event generated for the data traffic flow. The enriched network events are provided to a network management and control system, in some embodiments, which provides the UI through which the visualization is displayed, according to some embodiments.

In some embodiments, the contextual data is collected from a set of maps used to determine whether a data traffic flow is an ingress data traffic flow. A remote IP (Internet protocol) address, a local IP address, and a local port number are extracted from packets of each data traffic flow, in some embodiments, and used to query the set of maps. In some embodiments, the set of maps includes an IP-to-object map that maps IP addresses to their corresponding objects in the cluster, a service-to-workload object map that maps services to workloads in the cluster, a NodePort-to-service object map that maps NodePorts to service objects in the cluster, and a public IP address-to-service object map that maps public IP addresses to service objects in the cluster.

Data traffic flows are determined to be ingress data traffic flows, in some embodiments, when a particular set of conditions are met by the data traffic flow. In some embodiments, as a first example, a data traffic flow is determined to be an ingress data traffic flow when (1) the extracted remote IP address does not match to any IP addresses associated with any objects in the IP-to-object map, (2) the extracted local IP address matches to an IP address associated with a node object in the IP-to-object map, (3) the extracted local port number matches to a port number associated with a service in the NodePort-to-service object map, (4) the service is associated with a cluster IP address that corresponds to the particular cluster of destination workloads, and (5) a service object associated with the service matches to a workload in the service-to-workload map.

As a second example, in some embodiments, a data traffic flow is determined to be an ingress data traffic flow when (1) the extracted remote IP address does not match to any IP addresses associated with any objects in the IP-to-object map, (2) the extracted local IP address does not match to any IP addresses associated with any objects in the IP-to-object map, (3) the extracted local IP address does not match to any IP addresses associated with any services in the public IP-to-service object map, (4) the extracted local port number matches to a port number associated with a service in the NodePort-to-service object map, (5) the service is associated with a cluster IP address that corresponds to the particular cluster of destination workloads, and (6) a service object associated with the service matches to a workload in the service-to-workload map.

As a third and final example, in some embodiments, a data traffic flow is determined to be an ingress data traffic flow when (1) the extracted remote IP address does not match to any IP addresses associated with any objects in the IP-to-object map, (2) the extracted local IP address does not match to any IP addresses associated with any objects in the IP-to-object map, (3) the extracted local IP address matches to an IP address associated with a service object in the public IP-to-service object map, (4) the service is associated with a cluster IP address that corresponds to the particular cluster of destination workloads, and (5) a service object associated with the service matches to a workload in the service-to-workload map.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, the Detailed Description, the Drawings, and the Claims is needed. Moreover, the claimed subject matters are not to be limited by the illustrative details in the Summary, the Detailed Description, and the Drawings.

### BRIEF DESCRIPTION OF FIGURES

The novel features of the invention are set forth in the appended claims. However, for purposes of explanation, several embodiments of the invention are set forth in the following figures.

FIG. 1 illustrates an example of a control system of some embodiments of the invention.

FIG. 2 conceptually illustrates an example of a cluster of some embodiments.

FIG. 3 conceptually illustrates a diagram of a VPC in which at least one cluster is deployed, in some embodiments.

FIG. 4 conceptually illustrates a process performed in some embodiments to identify and display visualizations of ingress data traffic flows terminating on a workload cluster.

FIG. 5 conceptually illustrates an example of a UI of some embodiments that displays the visualizations generated for network events.

FIG. 6 conceptually illustrates a UI of some embodiments displaying a visualization that includes all flows.

FIG. 7 conceptually illustrates a process performed in some embodiments to identify and classify ingress data traffic flows received by workloads in a workload cluster.

FIG. 8 conceptually illustrates a computer system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments of the invention provide a method for identifying and generating visualizations of ingress data traffic flows to a workload cluster in a software-defined network (SDN). The method identifies, from multiple data traffic flows (e.g., ingress data traffic flows, egress data traffic flows, and internal data traffic flows) associated with a particular cluster of destination workloads, a set of ingress data traffic flows destined to the particular cluster of destination workloads. For each identified ingress data traffic flow, the method identifies a service from a set of services (e.g., load balancer services and NodePort services) through which the ingress data traffic flow reached the particular cluster of destination workloads. The method then generates, for display through a user interface (UI), a visualization that includes representations of each workload in the particular cluster of destination workloads, representations of the set of services through which the set of ingress data traffic flows reach the particular cluster of destination workloads, and a representation of the set of ingress data traffic flows terminating on the particular cluster of destination workloads.

In some embodiments, the UI includes a set of selectable UI items for modifying the visualization and viewing data associated with the identified ingress data traffic flows. The viewable data, in some embodiments, includes both five-tuple data associated with the ingress data traffic flows, as well as contextual data associated with the ingress data traffic flows. The contextual data, in some embodiments, includes ingress service type (e.g., load balancer or NodePort), service name, service namespace, public port number, public IP (Internet protocol) address and/or domain name, service cluster IP address (i.e., an IP address associated with the set of services), workload kind, workload name, a workload namespace, and a workload port number. In some embodiments, the data also includes the transport layer protocol, the application layer protocol, and an indication of an amount of data in bytes exchanged during the ingress data traffic flow.

The data provided through the UI, in some embodiments, is based on data used to enrich network events generated for each data traffic flow associated with the particular cluster of workloads. When identifying the set of ingress data traffic flows, in some embodiments, contextual data associated with each data traffic flow is collected and added to the network event generated for the data traffic flow. The enriched network events are provided to a network management and control system, in some embodiments, which provides the UI through which the visualization is displayed, according to some embodiments.

In some embodiments, the contextual data is collected from a set of maps used to determine whether a data traffic flow is an ingress data traffic flow. A remote IP (Internet protocol) address, a local IP address, and a local port number are extracted from packets of each data traffic flow, in some embodiments, and used to query the set of maps. In some embodiments, the set of maps includes an IP-to-object map that maps IP addresses to their corresponding objects in the cluster, a service-to-workload object map that maps services to workloads in the cluster, a NodePort-to-service object map that maps NodePorts to service objects in the cluster, and a public IP address-to-service object map that maps public IP addresses to service objects in the cluster.

Data traffic flows are determined to be ingress data traffic flows, in some embodiments, when a particular set of conditions are met by the data traffic flow. In some embodiments, as a first example, a data traffic flow is determined to be an ingress data traffic flow when (1) the extracted remote IP address does not match to any IP addresses associated with any objects in the IP-to-object map, (2) the extracted local IP address matches to an IP address associated with a node object in the IP-to-object map, (3) the extracted local port number matches to a port number associated with a service in the NodePort-to-service object map, (4) the service is associated with a cluster IP address that corresponds to the particular cluster of destination workloads, and (5) a service object associated with the service matches to a workload in the service-to-workload map.

As a second example, in some embodiments, a data traffic flow is determined to be an ingress data traffic flow when (1) the extracted remote IP address does not match to any IP addresses associated with any objects in the IP-to-object map, (2) the extracted local IP address does not match to any IP addresses associated with any objects in the IP-to-object map, (3) the extracted local IP address does not match to any IP addresses associated with any services in the public IP-to-service object map, (4) the extracted local port number matches to a port number associated with a service in the NodePort-to-service object map, (5) the service is associated with a cluster IP address that corresponds to the particular cluster of destination workloads, and (6) a service object associated with the service matches to a workload in the service-to-workload map.

As a third and final example, in some embodiments, a data traffic flow is determined to be an ingress data traffic flow when (1) the extracted remote IP address does not match to any IP addresses associated with any objects in the IP-to-object map, (2) the extracted local IP address does not match to any IP addresses associated with any objects in the IP-to-object map, (3) the extracted local IP address matches to an IP address associated with a service object in the public IP-to-service object map, (4) the service is associated with a cluster IP address that corresponds to the particular cluster of destination workloads, and (5) a service object associated with the service matches to a workload in the service-to-workload map.

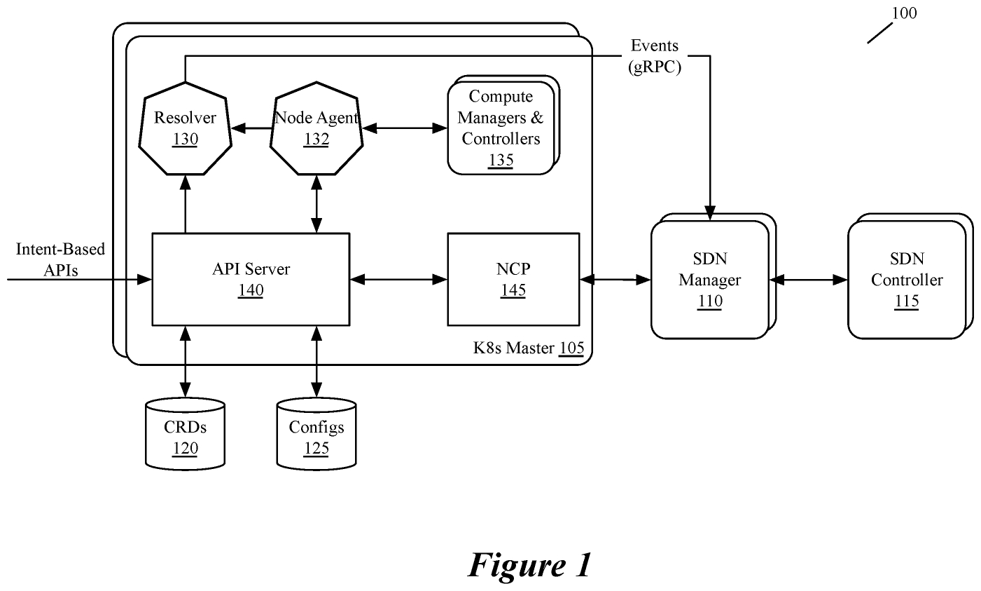

FIG. 1 illustrates an example of a control system 100 of some embodiments of the invention. In some embodiments, the control system 100 identifies ingress data traffic flows, enriches network events associated with those flows with contextual data, and provides the enriched network events to network managers and network controllers for generating visualizations of the ingress data traffic flows for display through a user interface (UI). Additionally, the control system 100 of some embodiments also processes APIs that use a Kubernetes-based declarative model to describe the desired state of (1) the machines to deploy, and (2) the connectivity, security and service operations that are to be performed for the deployed machines (e.g., private and public IP addresses connectivity, load balancing, security policies, etc.). To process APIs, the control system 100 of some embodiments uses one or more CRDs (custom resource definitions) to define some of the resources referenced in the APIs. The system 100 performs automated processes to deploy a logical network that connects the deployed machines and segregates these machines from other machines in the datacenter set. The machines are connected to the deployed logical network of a virtual private cloud (VPC) in some embodiments.

As shown, the control system 100 includes two or more master nodes 105 for API processing, a software defined network (SDN) manager cluster 110, and an SDN controller cluster 115. Each of the master nodes 105 includes an API processing server 140, a resolver 130, a node agent 132, compute managers and controllers 135, and a network controller plugin (NCP) 145. The API processing server 140 receives intent-based API calls and parses these calls. In some embodiments, the received API calls are in a declarative, hierarchical Kubernetes format, and may contain multiple different requests.

The API processing server 140 parses each received intent-based API request into one or more individual requests. When the requests relate to the deployment of machines, the API server provides these requests directly to compute managers and controllers 135, or indirectly provide these requests to the compute managers and controllers 135 through the node agent 132 and/or the NCP 145 running on the Kubernetes master node 105. The compute managers and controllers 135 then deploy VMs and/or sets of containers on host computers in the availability zone.

The API calls can also include requests that require network elements to be deployed. In some embodiments, these requests explicitly identify the network elements to deploy, while in other embodiments the requests can also implicitly identify these network elements by requesting the deployment of compute constructs (e.g., compute clusters, containers, etc.) for which network elements have to be defined by default. The control system 100 uses the NCP 145 to identify the network elements that need to be deployed, and to direct the deployment of these network elements.

In some embodiments, the API calls refer to extended resources that are not defined per se by the baseline Kubernetes system. For these references, the API processing server 140 uses one or more CRDs 120 to interpret the references in the API calls to the extended resources. The CRDs in some embodiments define extensions to the Kubernetes networking requirements. In some embodiments, the CRDs can include network-attachment-definition (NDs), Virtual Network Interfaces (VIF) CRDs, Virtual Network CRDs, Endpoint Group CRDs, security CRDs, Virtual Service Object (VSO) CRDs, and Load Balancer CRDs. In some embodiments, the CRDs are provided to the API processing server 140 in one stream with the API calls.

NCP 145 is the interface between the API server 140 and the SDN manager cluster 110 that manages the network elements that serve as the forwarding elements (e.g., switches, routers, bridges, etc.) and service elements (e.g., firewalls, load balancers, etc.) in an availability zone. The SDN manager cluster 110 directs the SDN controller cluster 115 to configure the network elements to implement the desired forwarding elements and/or service elements (e.g., logical forwarding elements and logical service elements) of one or more logical networks. The SDN controller cluster 115 interacts with local controllers on host computers and edge gateways to configure the network elements in some embodiments.

In some embodiments, NCP 145 registers for event notifications with the API server 140, e.g., sets up a long-pull session with the API server to receive all CRUD (Create, Read, Update and Delete) events for various CRDs that are defined for networking. In some embodiments, the API server 140 is a Kubernetes master VM, and the NCP 145 runs in this VM as a Pod. NCP 145 in some embodiments collects realization data from the SDN resources for the CRDs and provides this realization data as it relates to the CRD status. In some embodiments, the NCP 145 communicates directly with the API server 140 and/or through the node agent 132.

In some embodiments, NCP 145 processes the parsed API requests relating to NDs, VIFs, virtual networks, load balancers, endpoint groups, security policies, and VSOs, to direct the SDN manager cluster 110 to implement (1) the NDs that designate network segments for use with secondary interfaces of sets of containers, (2) the VIFs needed to connect VMs and sets of containers to forwarding elements on host computers, (3) virtual networks to implement different segments of a logical network of the VPC, (4) load balancers to distribute the traffic load to endpoint machines, (5) firewalls to implement security and admin policies, and (6) exposed ports to access services provided by a set of machines in the VPC to machines outside and inside of the VPC. In some embodiments, rather than directing the manager cluster 110 to implement the NDs, VIFs, virtual networks, load balancers, endpoint groups, security policies, and VSOs, the NCP 145 in some embodiments communicates directly with the SDN controller cluster 115 to direct the controller cluster 115 to implement the NDs, VIFs, virtual networks, load balancers, endpoint groups, security policies, and VSOs.

The API server 140 provides the CRDs 120 that have been defined for these extended network constructs to the NCP 145 for it to process the APIs that refer to the corresponding network constructs (e.g., network segments). The API server 140 also provides configuration data from the configuration storage 125 to the NCP 145. The configuration data in some embodiments include parameters that adjust the pre-defined template rules that the NCP 145 follows to perform its automated processes. In some embodiments, the configuration data includes a configuration map. The configuration map of some embodiments may be generated from one or more directories, files, or literal values. In some embodiments, the configuration map is generated from files in the configuration storage 125, from data received by the API server from the NCP and/or from data generated by the SDN manager 110. The configuration map in some embodiments includes identifiers of pre-created network segments of the logical network.

The NCP 145 performs these automated processes to execute the received API requests in order to direct the SDN manager cluster 110 to deploy the network elements for the VPC. For a received API, the control system 100 performs one or more automated processes to identify and deploy one or more network elements that are used to implement the logical network for a VPC. The control system performs these automated processes without an administrator performing any action to direct the identification and deployment of the network elements after an API request is received.

The SDN managers 110 and controllers 115 can be any SDN managers and controllers available today. In some embodiments, these managers and controllers are the NSX-T managers and controllers licensed by VMware, Inc. In such embodiments, NCP 145 detects network events by processing the data supplied by its corresponding API server 140, and uses NSX-T APIs to direct the NSX-T manager 110 to deploy and/or modify NSX-T network constructs needed to implement the network state expressed by the API calls. The communication between the NCP and NSX-T manager 110 is asynchronous communication, in which the NCP provides the desired state to NSX-T managers, which then relay the desired state to the NSX-T controllers to compute and disseminate the state asynchronously to the host computer, forwarding elements and service nodes in the availability zone (i.e., to the SDDC set controlled by the controllers 115). After receiving the APIs from the NCPs 145, the SDN managers 110 in some embodiments direct the SDN controllers 115 to configure the network elements to implement the network state expressed by the API calls. In some embodiments, the SDN controllers serve as the central control plane (CCP) of the control system 100.

In some embodiments, in addition to the node agent 132 (e.g., Kubernetes Kubelet) executing on the master node 105, each worker node in a cluster has its own respective node agent that can register the respective worker node with the API server 140. In some embodiments, the node agents register their nodes using one of: the hostname; a flag to override the hostname; or specific logic for a cloud provider. The node agent 132 receives sets of containerspecs, YAML (a data serialization language) or JavaScript Object Notation (JSON) formatted objects that each describe a pod. The node agent 132 uses sets of containerspecs to create (e.g., using the compute managers and controllers 135) the sets of containers that are provided by various mechanism elements (e.g., from the API server 140) and ensures that the containers described in those sets of containerspecs are running and healthy.

The resolver 130 receives summarized network events from the node agent 132 and other node agents (not shown) deployed to the worker nodes of the cluster. The network events are captured and summarized by the node agents, like node agent 132, and provided to the resolver 130. In some embodiments, one resolver is deployed per cluster, while in other embodiments, a cluster may include more than one resolver. The resolver 130 receives contextual data from the API server 140, and marries this contextual data to the network events from the node agent 132 in order to create enriched network events. The resolver 130 is also responsible for classifying the network events as ingress, egress, or internal network events. Once the network events have been enriched with the contextual data and classified, the resolver 130 compresses the events and sends the compressed network events to, e.g., the network managers 110 and/or the SDN controller 115, in some embodiments, which then generate visualizations of the network events for display through a UI provided by the managers and controllers. In other embodiments, the resolver 130 instead sends the compressed network events to the managers and controllers through the NCP 145.

In some embodiments, the resolver 130 receives notifications upon each create, update, or delete operation on each pod, ReplicaSet, job, node, service, endpoint, and endpoint slice object with its cluster from the API server 140. The resolver 130 uses this information from the API server 140 to create a set of mappings and keep them up-to-date. The mappings, in some embodiments, include an IP-to-Kubernetes Object map that maps each Kubernetes node object to a node IP address, each service object to its cluster IP address, and each pod object to one of its assigned IP addresses; a Public IP-to-Kubernetes Service Object map that maps service objects to the one or more public IP addresses assigned to each service object; a NodePort-to-Service map that maps service objects to node port numbers that are associated with each service object; and a Service-to-Workload map that maps service objects to workload objects (e.g., pods, ReplicaSets, Stateful Sets, DaemonSets, deployments, jobs, CronJobs, etc.).

In some embodiments, the resolver 130 stores the mappings in a mappings storage (not shown) for use in classifying network events and the corresponding data traffic flows. Upon object deletion (i.e., when an object is deleted from the cluster), its relevant mappings are not removed immediately, but are retained for an additional 60 seconds, according to some embodiments. As a result, in some embodiments, late-arriving network events from the node agent 132 can be processed correctly.

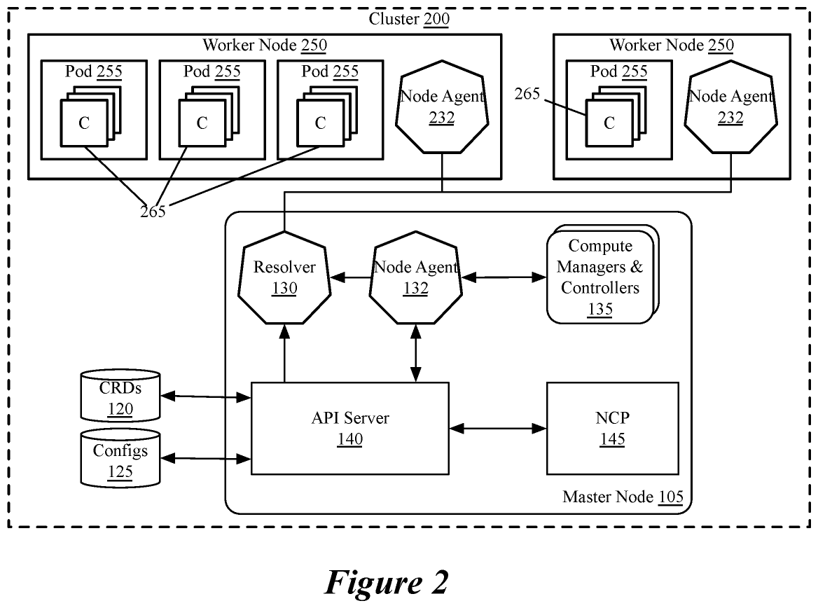

FIG. 2 conceptually illustrates an example of a cluster 200 of some embodiments. In this example, the cluster 200 includes the master node 105 discussed above and a set of worker nodes 250. Each worker node 250 includes one or more pods 255 that each run one or more containers 265, and, like the master node 105, each worker node 250 also includes a node agent 232. The node agents 132 and 232 communicate with the resolver 130 on the master node 105, as shown. As the node agents 132 and 232 detect connections and create new network events, the node agents 132 and 232 fill in certain information in the fields of the network events, and provide the network events to the resolver 130 for enrichment and classification.

Each cluster 200 includes at least one worker node 250, which run containerized applications. Each worker node 250 is a worker machine, such as a virtual machine or a physical machine. While illustrated as the master node 105, the control plane components for a cluster can be run on any machine (i.e., any node) in the cluster. In some embodiments, such as the control system 100 and the cluster 200, the control plane components run on the same machine rather than across various machines (i.e., nodes) of the cluster. Each of the worker nodes 250 of the cluster 200 are managed by the control plane components running on the master node 105, and more broadly by the entire control system 100 described above, according to some embodiments. The control system schedules pods 255 across the worker nodes 250 in the cluster 200 based on, in some embodiments, the available resources of each node in the cluster. The node agents 132 and 232 are responsible for communications between the control plane (e.g., control system 100) and their respective nodes. Additionally, each node agent 132 and 232 is responsible for managing any pods and containers running on their respective nodes.

Kubernetes clusters use pods 255 as their atomic scheduling unit. Each workload that's deployed on a cluster results in creating one or more pods, according to some embodiments. These pods are then started and executed on a Kubernetes cluster node, such as the worker nodes 250, and stay there until they are evicted or deleted. Each Kubernetes node is a physical or virtual machine, as mentioned above, that is joined to a Kubernetes cluster to run the pods of that cluster. Services and endpoints, in some embodiments, are used to expose functionality over the network in a seamless manner. Each service creates a logical unit of a DNS name, an IP address, and exposed service and node ports. These can then be mapped to one or more Kubernetes workloads, which provide an implementation for that service.

Each Kubernetes workload, in some embodiments, is an application. In some embodiments, a workload can be a single component or a collection of components that work together (e.g., inside a set of pods). Examples of workload objects, in some embodiments, include Deployments (e.g., for managing stateless application workloads on a cluster) and ReplicaSets (which replace ReplicationControllers), Stateful Sets (e.g., running one or more related pods that track state), DaemonSets (e.g., pods that provide node-local facilities), Jobs (e.g., defined one-off tasks that run to completion and then end), and CronJobs (e.g., scheduled recurring tasks). In some embodiments, because Kubernetes workloads consist of one or more pods, and Kubernetes services track only workloads, it is necessary to track the available pods per workload for a specific service using endpoint objects, which track all available pods for a service, their IP addresses, and port numbers. All Kubernetes objects, regardless of their type, are tracked by the API server 140, which can be accessed by workloads, nodes, and users alike.

In some embodiments, pods, nodes, and most services have designated unique IP addresses within the cluster and can make network connections between themselves or the API server 140. This creates the perception of a single large network that has everything in the cluster running as an endpoint connected to that network, according to some embodiments, while the reality is that only the Kubernetes nodes 105 and 250 and, in some embodiments, possibly some helper services (e.g., the API server 140 and an ingress traffic Load Balancer (not shown)) are connected in a single network. The pod and service endpoints are included in a larger software defined network (SDN) that uses the node network (and all endpoints in it) as its basis of operation, according to some embodiments.

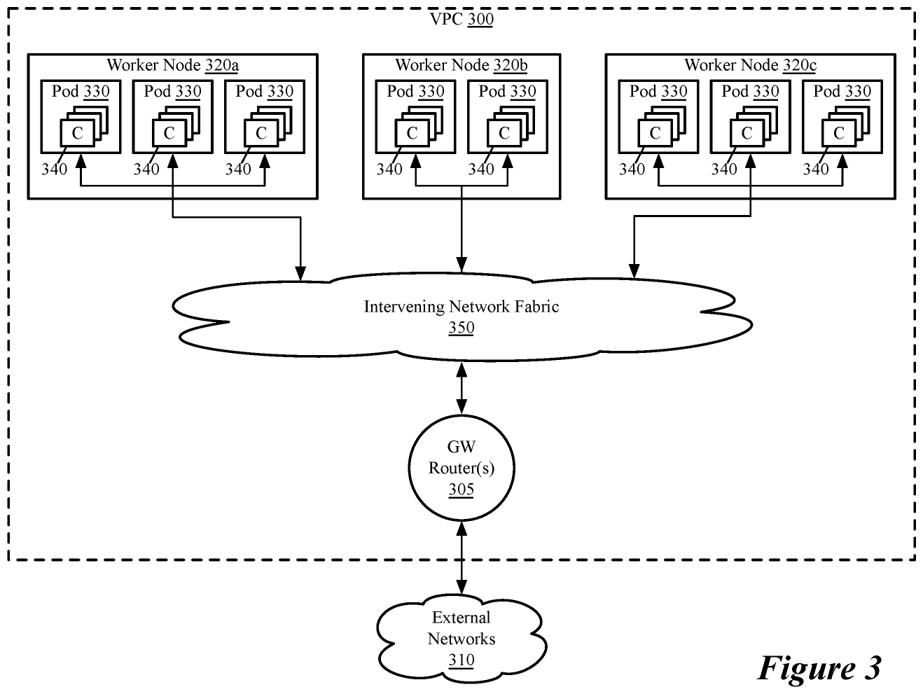

In some embodiments, clusters are deployed to virtual private clouds (VPCs) or other public or private network environments. FIG. 3 conceptually illustrates a diagram of a VPC in which at least one cluster is deployed, in some embodiments. As shown, the VPC 300 includes a gateway router 305, intervening network fabric 350, and multiple worker nodes 320a, 320b, and 320c that each include multiple pods 330 that each execute a respective set of containers 340. In some embodiments, multiple worker nodes belonging to different clusters are deployed to the VPC 300, while in other embodiments, the worker nodes 320a-320c belong to the same cluster.

The worker nodes 320a-320c are virtual machines, in some embodiments, and physical machines in other embodiments. In some embodiments, each worker node includes a VNIC (virtual network interface card) (not shown) that passes data traffic to and from the pods 330 executing on the worker nodes 320a-320c. In some embodiments, the intervening network fabric 350 includes one or more layers of virtual switches that execute on the worker nodes 320a-320c and/or on the host computers (not shown) that host the worker nodes 320a-320c. In addition to the virtual switches, one or more layers of routers are also part of the intervening network fabric 350, according to some embodiments. These routers, in some embodiments, execute on the hosts (not shown) of the worker nodes 320a-320c and/or outside of the hosts.

In some embodiments, the virtual switches (not shown) that are part of the intervening network fabric 350 and execute on the worker nodes 320a-320c include specific ports or interfaces (not shown) that correspond to the different pods 330 executing on the worker nodes 320a-320c, and the virtual switches forward data traffic to and from the pods 330 based on the ports and interfaces on which the data traffic is received. Such data traffic can include ingress data traffic, egress data traffic, and internal data traffic, according to some embodiments. In some embodiments, the virtual switches (not shown) executing on the worker nodes 320a-320c are OVS (Open vSwitch) bridges, which are widely adopted high-performance programmable virtual switches originating from VMware, Inc. that is designed to enable effective network automation through programmatic extensions. These OVS bridges, in some embodiments, also allow pods belonging to different namespaces to execute on the same worker nodes, and route ingress, egress, and internal data traffic for the pods based on the ports and/or interfaces on which the data traffic is received.

The gateway router 305 receives and forwards ingress data traffic directed to the VPC 300, as well as egress data traffic originating from the VPC 300. While illustrated as a single forwarding element, the gateway router 305, in some embodiments, is multiple forwarding elements (e.g., multiple switches, routers, etc.) for forwarding data traffic flows to and from worker nodes 320a-320c deployed to the VPC 300. In some embodiments, the gateway router 305 includes multiple components—a service router (SR) component, a distributed router (DR) component, and a switch component—for handling data traffic flow associated with the VPC 300, such as by performing network address translation (NAT) operations on data traffic, encapsulation and decapsulation operations on data traffic, as well as forwarding operations on data traffic.

In some embodiments, the intervening network fabric 350 includes Kubernetes services that are deployed to expose the pods 330 and/or containers 340 executing on the worker nodes 320a-320c in the VPC 300. For instance, in some embodiments, a load balancer service and/or a node port service (not shown) are deployed as part of the intervening network fabric 350 to expose the pods 330 and/or containers 340. These services, in some embodiments, are abstract means of exposing the applications (i.e., workloads) running on the pods 330 (i.e., as containerized applications). In some embodiments, each pod has its own IP address and a single DNS name is assigned to a set of pods, and the load balancing service is able to load-balance across the pods.

The set of pods (i.e., endpoints) targeted by the service (e.g., load balancer service) is determined, in some embodiments, by a selector. The selectors enable selection of Kubernetes resources and services based on the value of labels and fields assigned to a set of pods or, in some embodiments, to a set of nodes. A controller for the selector continuously scans for pods 330 that match the selector (i.e., match the value of the label and fields), according to some embodiments. In some embodiments, the load balancer service tracks the availability of the pods 330 using the Kubernetes Endpoints API, which indicate the current status of the endpoints (e.g., pods), in some embodiments.

The NodePort service, in some embodiments, is an open port on every worker node 320a-320c that has a pod 330 for a particular service, and when ingress data traffic is received on that open port, the ingress data traffic is directed to a specific port on the cluster IP address for the service that the port represents. That is, the NodePort exposes the service on each worker node's IP address at a static port (i.e., the NodePort), and to make the node port available, in some embodiments, a cluster IP address is set up (e.g., service type ClusterIP), while the load balancer service of some embodiments exposes the service to external networks 310. The NodePort service, in some embodiments, can be accessed from the external networks 310, or from any other elements outside of the cluster to which the worker nodes 320a-320c belong, by connecting to any node 320a-320c using the appropriate protocol (e.g., TCP, UDP, etc.) and the appropriate port number assigned to that service. When there are multiple worker nodes 320a-320c, the load balancer service in some embodiments helps to spread ingress data traffic across the worker nodes.

As such, data traffic directed to the VPC 300 arrives at the gateway router 305, and once the data traffic enters the VPC 300, in some embodiments, forwarding elements (e.g., virtual switches, routers, bridges, etc.) and services that are deployed to the VPC 300 and part of the intervening network fabric 350 work to direct the ingress data traffic to appropriate pods 330 on the worker nodes 320a-320c. For instance, a load balancer service and/or NodePort service works to direct the ingress traffic to one of the pods 330 and/or containers 340. Once the ingress data traffic flows are received at one of the worker nodes 320a-320c, in some embodiments, the virtual switches that are part of the intervening network fabric 350 forward the ingress data traffic to the appropriate pods 330 (e.g., according to the NodePort and/or load balancer service), where the containers 340 perform services and operations. Additional details regarding the NodePort and load balancer services will be described further below.

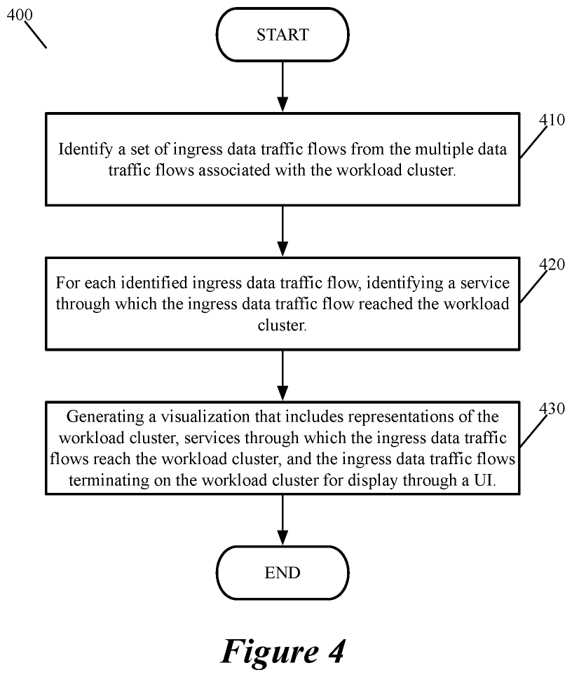

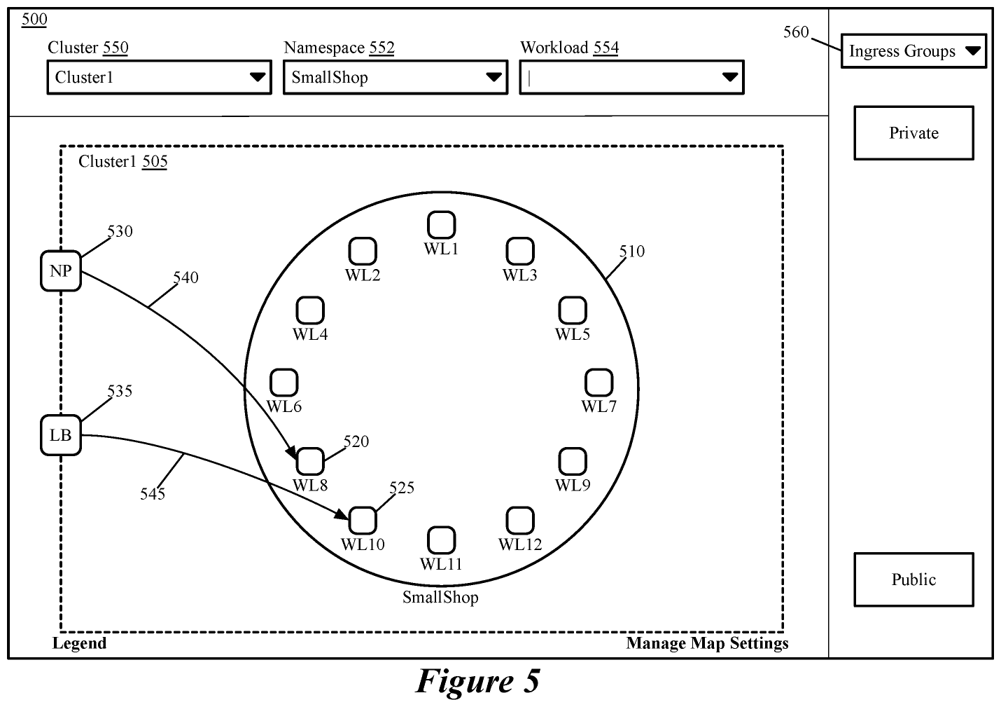

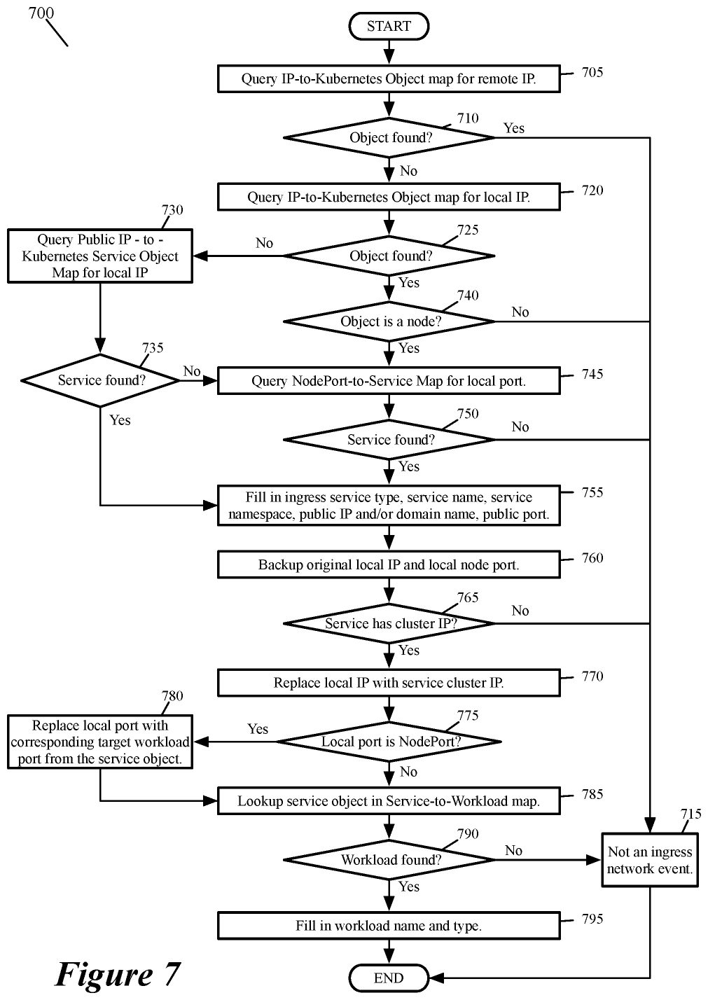

FIG. 4 conceptually illustrates a process 400 performed in some embodiments to identify and display visualizations of ingress data traffic flows terminating on a workload cluster. The process 400 will be described below with references to FIG. 5, which conceptually illustrates an example of a UI of some embodiments that displays the visualizations generated for network events. The process 400 starts when the process identifies (at 410) a set of ingress data traffic flows from multiple data traffic flows associated with the workload cluster. As described above, traffic classification is performed by a resolver deployed for a cluster. The resolver uses network event data received from node agents, contextual data received from an API server, and mappings it has created based on other information from the API server, to analyze and classify network events from the node agents. Further details regarding the resolver's process of traffic classification will be described further below by FIG. 7.

For each identified ingress data traffic flow, the process 400 identifies (at 420) a service through which the ingress data traffic flow reached the workload cluster. Ingress traffic can enter a private network of a workload cluster and be routed to the pods for the workloads the traffic is intended for through a variety of ways, as also mentioned above. In some embodiments, each service of type “NodePort” or “LoadBalancer” allocates one or more “node ports”, which are unique port numbers that are opened on each node. These node ports seamlessly redirect traffic that they receive to one or more endpoints, according to some embodiments.

In a first example in which ingress traffic enters by a load balancer through a node port of a service, once a load balancer that acts as an ingress point for a workload cluster gets a net connection, the load balancer checks which service the traffic is intended for. In some embodiments, the load balancer checks the target IP address and/or domain name, and the target port number. Once the service is known, the appropriate node port (i.e., for the ingress target port number used) is fetched and one of the node IP addresses is selected. The connection is then redirected to the node IP address/port pair. From then on, in some embodiments, the ingress traffic is internally redirected to one of the pods that need to handle the traffic based on service to pod endpoint mappings.

It should be noted that, in some embodiments, the pod that handles ingress traffic might not run on the node that gets the redirected traffic from the load balancer. In some such embodiments, when monitoring in-cluster traffic, two connections would exist for this ingress traffic. Namely, one connection from the load balancer (or other ingress service) to one of the cluster nodes on a specific node port, and one connection from the node used in the previous connection to one of the pods of the target workload. The relation between these two connections, in some embodiments, is not always obvious as a single node can also handle multiple connections to different pods of the same workload for the same service.

In another example in which ingress traffic enters through a load balancer and is directed to a pod, the load balancer/ingress service tracks not only the service objects, but also the endpoints objects as well, which allows the load balancer to send ingress traffic directly to one of the pods of the workload for which the connection is intended. In some such embodiments, the load balancer first uses the same algorithm it uses in the first example described above to locate the corresponding service object. The load balancer then uses that object to locate the corresponding endpoints information. Using a specific load balancer algorithm, the load balancer picks up one of the endpoints (e.g., a pod for the target workload) and uses its IP address and port number to send traffic directly to the endpoint.

In some embodiments of this example, when monitoring in-cluster traffic, two connections for the ingress traffic can be identified. The first connection of some such embodiments is from the load balancer to one of the pods that should handle this specific connection. The second connection of some such embodiments is optional and is from the actual ingress traffic initiator to one of the public IP addresses associated with the service handling the ingress traffic for the target workload.

Returning to the process 400, the process generates (at 430) a visualization that includes representations of the workload cluster, services through which the ingress data traffic flows reach the workload cluster, and the ingress data traffic flows terminating on the workload cluster for display through a UI. The UI 500 of FIG. 5 illustrates an example of such a visualization in some embodiments. As shown, the UI 500 includes a visualization of a cluster 505 “Cluster1”, a visualization of a namespace 510 “SmallShop” within the cluster 505, ingress services 530 and 535, and multiple workloads that include target workloads 520 and 525.

The UI 500 includes visualizations of ingress data traffic flows that enter using both of the examples described above. In this example, ingress groups 560 are selected for display. A first connection (or set of connections) 540 enter the cluster through NodePort service 530 and terminate on the workload 520, while a second connection (or set of connections) 545 enter through the load balancer service 535 and terminate on the workload 525. Each connection 540-545 may each represent a single flow or multiple flows, according to some embodiments.

The workloads 520 and 525, in some embodiments, each represent, e.g., one of a web server (e.g., HTTP server), a database server, or an application server. Also, in some embodiments, each workload 520 and 525 represents a full application (i.e., web server, application server, and database server) that runs on multiple pods or multiple containers, which may be deployed to the same worker node in the cluster, or, in some embodiments, to multiple different worker nodes in the cluster.

The UI 500 includes selectable items 550-554 to enable a user (e.g., via a cursor control device or other pointing or selection device) to manipulate the visualization and, e.g., drill down further to view the visualization at the workload level by selecting a workload 554, or e.g., zoom out to the cluster level. As illustrated, the UI 500 displays the visualization at the namespace level in this example, indicated by the cluster selected 550 and namespace selected 552.

Each namespace, in some embodiments, is an isolated group of resources within a single cluster. Names of resources within each namespace must be unique within the namespace, but can overlap across different namespaces. In some embodiments, namespaces are used in environments with many users spread across multiple different teams, projects, divisions, etc. in order to isolate resources for each team, project, division, etc. and to divide resources between each team, project, division, etc. Pods belonging to different namespaces can run on the same worker node, according to some embodiments. In some embodiments, only certain workloads within the namespace 510 of the cluster 505 are reachable from outside of the cluster 505. For example, the namespace 510 in some embodiments is an online shop that includes various workloads such as payment services, database services, cronjobs, etc., that are only associated with internal data traffic flows and egress data traffic flows, while the workloads 520 and 525 are responsible for displaying a website for the online shop on the front end, and thus are the only workloads in the namespace 510 that can be reached from external sources.

The clusters are sets of nodes that run containerized applications. Each cluster includes worker nodes, and a group of pods, related or unrelated, run on a cluster, which can include many pods. In some embodiments, each cluster, namespace, workload, service, and connection displayed through the UI 500 is a selectable item and upon being selected, the UI 500 displays additional information regarding the selected item, such as any network event data associated with the selected item. Returning to the process 400, following 430, the process ends.

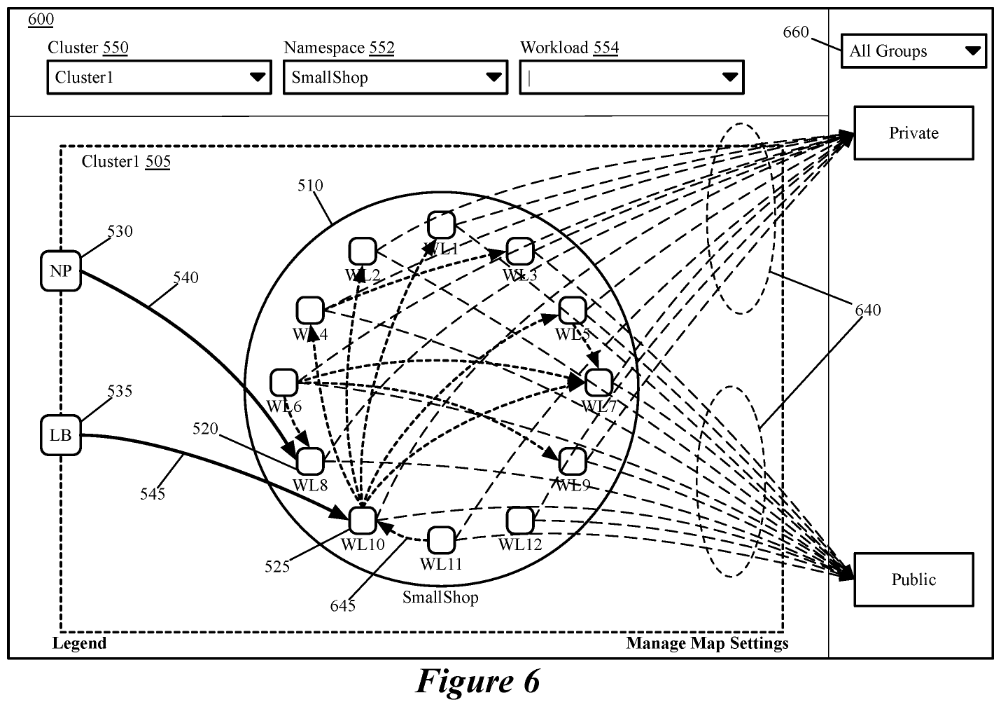

In some embodiments, in addition to viewing the ingress data traffic flows, users can also select to view egress flows, internal flows, or any combination of ingress, egress, and internal flows, including all flows or no flows. FIG. 6, for example, conceptually illustrates a UI 600 of some embodiments displaying a visualization that includes all flows. Unlike the UI 500, the UI 600 shows that all groups 660 have now been selected. As such, in addition to the ingress connections 540 and 545, the UI 600 also displays multiple internal connections 645 and egress connections 640, which include egress connections to a public datacenter and a private datacenter.

FIG. 7 conceptually illustrates a process 700 performed in some embodiments to identify and classify ingress data traffic flows received by workloads in a workload cluster. The process 700, in some embodiments, is performed by a resolver for a workload cluster (e.g., resolver 130) upon receiving a network event corresponding to a data traffic flow associated with the workload cluster from a node agent (e.g., any of node agents 132 and 232). In some embodiments, the node agent fills in certain fields for each network event it provides to the resolver for use in determining whether the network event and its corresponding data traffic flow are an ingress network event and ingress data traffic flow. These fields, in some embodiments, include transport layer protocol (e.g., TCP, UDP, etc.), application layer protocol when available (e.g., TLS, HTTP, SSH, etc.), remote IP address, remote domain name (if it is known), local IP address, local port number, and the amount of data transferred (in bytes). As will be described for the process 700 below, the resolver uses the data from the network events to query maps it has generated for the workload cluster. In some embodiments, the network events are provided to the resolver in batches via gRPC.

The process 700 starts when the resolver queries (at 705) an IP-to-Kubernetes Object map for a remote IP address extracted from a network event corresponding to a data traffic flow being classified by the resolver. The IP-to-Kubernetes Object map maps each Kubernetes node object to a node IP address, each service object to its cluster IP address, and each pod object to one of its assigned IP addresses.

The process 700 determines (at 710) whether an object having an IP address corresponding to the remote IP address has been found in the IP-to-Kubernetes Object map. When an object having the remote IP address is found in the IP-to-Kubernetes Object map, the process 700 transitions to determine (at 715) that the network event is not an ingress network event (i.e., does not correspond to an ingress data traffic flow). In other words, if the mapping includes the source IP address (i.e., the remote IP address), then the source of the flow must be originating from within the cluster rather than externally. Following 715, the process 700 ends.

When no objects having the remote IP address are found in the IP-to-Kubernetes Object map, the process 700 transitions to query (at 720) the IP-to-Kubernetes Object map for a local IP address extracted from the network event. The process 700 determines (at 725) whether an object having an IP address corresponding to the local IP address has been found in the IP-to-Kubernetes Object map.

When no objects having an IP address corresponding to the local IP address have been found in the IP-to-Kubernetes Object map, the process 700 transitions to query (at 730) a Public IP-to-Kubernetes Service Object map for the local IP address. In some embodiments, load balancers allocate one or more public IP addresses per service object type “LoadBalancer”. The Public IP-to-Kubernetes Service Object map can be queried using IP addresses in order to find corresponding service objects based on the one or more public IP addresses assigned to each service object.

The process 700 determines (at 735) whether a service corresponding to the local IP address has been found in the Public IP-to-Kubernetes Service Object map. When no services corresponding to the local IP address have been found in the Public IP-to-Kubernetes Service Object map, the process transitions to query (at 745) a NodePort-to-Service map for a local port number extracted from the network event. The NodePort-to-Service map includes mappings between service objects and node port numbers that are associated with each service object. In some embodiments, each Kubernetes service of type “NodePort” or “LoadBalancer” exposes one or more node ports that are unique to it and open on all Kubernetes nodes for the purpose of redirecting service traffic to the pods that handle this service's connections.

Otherwise, when a service corresponding to the local IP address has been found in the Public IP-to-Kubernetes Service Object map, the process transitions to fill in (at 755) the ingress service type, service name, service namespace, public IP address and/or domain name, and public port number in appropriate fields in the network event. When the process 700 instead determines (at 725) that an object corresponding to the local IP address has been found in the IP-to-Kubernetes Object map, the process transitions to determine (at 740) whether the object is a node object. When the object is not a node object, the process transitions to determine (at 715) that the network event is not an ingress network event. Following 715, the process 700 ends.

When the object is a node object, the process transitions to query (at 745) the NodePort-to-Service map for a local port number extracted from the network event. The process then determines (at 750) whether a service object corresponding to the local port number has been found in the NodePort-to-Service map. When no service objects corresponding to the local port number are found in the NodePort-to-Service map, the process 700 transitions to determine (at 715) that the network event is not an ingress network event. Following 715, the process 700 ends.

When a service object corresponding to the local port number is found in the NodePort-to-Service map, the process 700 transitions to fill in (at 755) the ingress service type, service name, service namespace, public IP address and/or domain name, and public port number in appropriate fields in the network event using the identified service object. In some embodiments, this information can be viewed by a user through a UI, such as either of the UIs 500 and 600 described above.

The process 700 then backs up (at 760) the original local IP address and local port number in two new fields of the network event called “orig_local_ip” and “orig_local_port”. The process determines (at 765) whether the service object (i.e., found in either the Public IP-to-Kubernetes Service Object map or the NodePort-to-Service map) has a cluster IP address associated with it. That is, the process determines whether the service object belongs to the cluster. When the service object does not have the cluster IP address associated with it, the process 700 transitions to determine (at 715) that the network event is not an ingress network event. Following 715, the process 700 ends.

When the service object does have the cluster IP address associated with it, the process 700 transitions to replace (at 770) the local IP address with the cluster IP address. That is, in the network event field for the local IP address, which has been backed up in the new “orig_local_ip” field, with the cluster IP address. The process 700 then transitions to determine (at 775) whether the local port number is a NodePort.

When the local port number is not a NodePort, the process transitions to look up (at 785) the service object in a Service-to-Workload map. Otherwise, when the local port number is a NodePort, the process transitions to replace (at 780) the local port in the network event, which has also been backed up in the new “orig_local_port” field, with a corresponding target workload port number from the service object.

Following 780, the process 700 transitions to look up (at 785) the service object in the Service-to-Workload map. In the Service-to-Workload map, each Kubernetes workload object (e.g., pod, ReplicaSet, StatefulSet, DaemonSet, Deployment, Job, CronJob, etc.) is pointed to by a given Kubernetes Service object. As such, service objects can be used to query the Service-to-Workload map to identify workloads corresponding to each service object. The process 700 determines (at 790) whether a workload has been found in the Service-to-Workload map.

When no workloads have been found in the Service-to-Workload map, the process transitions to determine (at 715) that the network event is not an ingress network event. Following 715, the process 700 ends. Otherwise, when a workload has been found in the Service-to-Workload map, the process transitions to fill in (at 795) the workload name and type in corresponding fields of the network event. At this point, the network event is classified as an ingress network event, indicating the corresponding data traffic flow is an ingress data traffic flow. Following 795, the process 700 ends.

Many of the above-described features and applications are implemented as software processes that are specified as a set of instructions recorded on a computer-readable storage medium (also referred to as computer-readable medium). When these instructions are executed by one or more processing unit(s) (e.g., one or more processors, cores of processors, or other processing units), they cause the processing unit(s) to perform the actions indicated in the instructions. Examples of computer-readable media include, but are not limited to, CD-ROMs, flash drives, RAM chips, hard drives, EPROMs, etc. The computer-readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

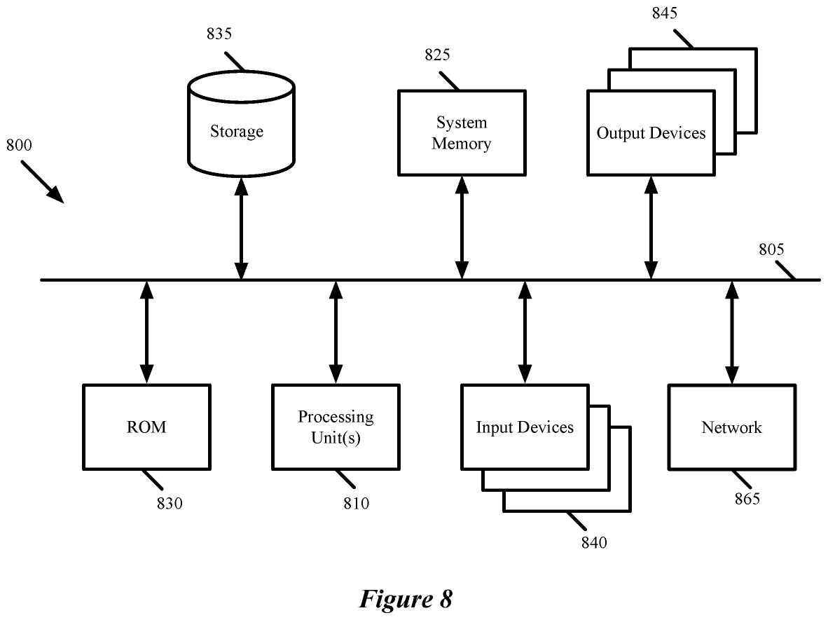

FIG. 8 conceptually illustrates a computer system 800 with which some embodiments of the invention are implemented. The computer system 800 can be used to implement any of the above-described hosts, controllers, gateway, and edge forwarding elements. As such, it can be used to execute any of the above described processes. This computer system 800 includes various types of non-transitory machine-readable media and interfaces for various other types of machine-readable media. Computer system 800 includes a bus 805, processing unit(s) 810, a system memory 825, a read-only memory 830, a permanent storage device 835, input devices 840, and output devices 845.

The bus 805 collectively represents all system, peripheral, and chipset buses that communicatively connect the numerous internal devices of the computer system 800. For instance, the bus 805 communicatively connects the processing unit(s) 810 with the read-only memory 830, the system memory 825, and the permanent storage device 835.

From these various memory units, the processing unit(s) 810 retrieve instructions to execute and data to process in order to execute the processes of the invention. The processing unit(s) 810 may be a single processor or a multi-core processor in different embodiments. The read-only-memory (ROM) 830 stores static data and instructions that are needed by the processing unit(s) 810 and other modules of the computer system 800. The permanent storage device 835, on the other hand, is a read-and-write memory device. This device 835 is a non-volatile memory unit that stores instructions and data even when the computer system 800 is off. Some embodiments of the invention use a mass-storage device (such as a magnetic or optical disk and its corresponding disk drive) as the permanent storage device 835.

Other embodiments use a removable storage device (such as a floppy disk, flash drive, etc.) as the permanent storage device. Like the permanent storage device 835, the system memory 825 is a read-and-write memory device. However, unlike storage device 835, the system memory 825 is a volatile read-and-write memory, such as random access memory. The system memory 825 stores some of the instructions and data that the processor needs at runtime. In some embodiments, the invention's processes are stored in the system memory 825, the permanent storage device 835, and/or the read-only memory 830. From these various memory units, the processing unit(s) 810 retrieve instructions to execute and data to process in order to execute the processes of some embodiments.

The bus 805 also connects to the input and output devices 840 and 845. The input devices 840 enable the user to communicate information and select commands to the computer system 800. The input devices 840 include alphanumeric keyboards and pointing devices (also called “cursor control devices”). The output devices 845 display images generated by the computer system 800. The output devices 845 include printers and display devices, such as cathode ray tubes (CRT) or liquid crystal displays (LCD). Some embodiments include devices such as touchscreens that function as both input and output devices 840 and 845.

Finally, as shown in FIG. 8, bus 805 also couples computer system 800 to a network 865 through a network adapter (not shown). In this manner, the computer 800 can be a part of a network of computers (such as a local area network (“LAN”), a wide area network (“WAN”), or an Intranet), or a network of networks (such as the Internet). Any or all components of computer system 800 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application-specific integrated circuits (ASICs) or field-programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms “display” or “displaying” mean displaying on an electronic device. As used in this specification, the terms “computer-readable medium,” “computer-readable media,” and “machine-readable medium” are entirely restricted to tangible, physical objects that store information in a form that is readable by a computer. These terms exclude any wireless signals, wired download signals, and any other ephemeral or transitory signals.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

1. A method for identifying and generating visualizations of ingress data traffic flows to a workload cluster in a software-defined network (SDN), the method comprising:
from a plurality of data traffic flows associated with a particular cluster of destination workloads in the SDN, identifying a set of ingress data traffic flows destined to the particular cluster of destination workloads;
for each identified ingress data traffic flow, identify a service from a set of services through which the ingress data traffic flow reached the particular cluster of destination workloads; and
generating a visualization for display through a user interface (UI), the visualization comprising (i) representations of each workload in the particular cluster of destination workloads, (ii) representations of the set of services through which the set of ingress data traffic flows reach the particular cluster of destination workloads, and (iii) a representation of the set of ingress data traffic flows terminating on the particular cluster of destination workloads.

2. The method of claim 1, wherein the plurality of data traffic flows comprise (i) ingress data traffic flows received from sources outside of the particular cluster of destination workloads, (ii) internal data traffic flows between workloads in the particular cluster of destination workloads, and (iii) egress data traffic flows sent from workloads in the particular cluster of destination workloads to destinations external to the particular cluster of destination workloads.

3. The method of claim 1, wherein the UI comprises a set of selectable UI items for (i) modifying the visualization and (ii) viewing data associated with the identified ingress data traffic flows.

4. The method of claim 3, wherein the data associated with the identified ingress data traffic flows comprises (i) five-tuple data associated with each identified ingress data traffic flow and (ii) contextual data associated with each identified ingress data traffic flow.

5. The method of claim 4, wherein a network event is generated for each identified ingress data traffic flow, wherein identifying the set of ingress data traffic flows further comprises:
collecting contextual data associated with each identified ingress data traffic flow; and
using the collected contextual data to annotate the network events generated for each data traffic flow in the plurality of data traffic flows.

6. The method of claim 5, wherein the contextual data comprises an ingress service type, a service name, a service namespace, a public port number, an IP address associated with the set of services, workload kind, workload name, a workload namespace, and a workload port number.

7. The method of claim 6, wherein the contextual data further comprises at least one of public IP (Internet protocol) address and domain name.

8. The method of claim 7, wherein the contextual data further comprises transport layer protocol, application layer protocol, and an indication of an amount of data in bytes exchanged during the ingress data traffic flow.

9. The method of claim 1, wherein identifying the set of ingress data traffic flows destined to the particular cluster of destination workloads comprises, for each data traffic flow in the plurality of data traffic flows:
extracting from packets belonging to the data traffic flow a remote IP (Internet protocol) address, a local IP address, and a local port number; and
using the extracted remote IP address and at least one of the extracted local IP address and the extracted local port number to query a set of maps to determine whether the data traffic flow is an ingress data traffic flow.

10. The method of claim 9, wherein the set of maps comprise (i) an IP-to-object map, (ii) a service-to-workload object map, (iii) a NodePort-to-service object map, and (iv) a public IP address-to-service object map.

11. The method of claim 10, wherein the data traffic flow is determined to be an ingress data traffic flow when (i) the extracted remote IP address does not match to any IP addresses associated with any objects in the IP-to-object map, (ii) the extracted local IP address matches to an IP address associated with a node object in the IP-to-object map, (iii) the extracted local port number matches to a port number associated with a service in the NodePort-to-service object map, (iv) the service is associated with a cluster IP address that corresponds to the particular cluster of destination workloads, and (v) a service object associated with the service matches to a workload in the service-to-workload map.

12. The method of claim 10, wherein the data traffic flow is determined to be an ingress data traffic flow when (i) the extracted remote IP address does not match to any IP addresses associated with any objects in the IP-to-object map, (ii) the extracted local IP address does not match to any IP addresses associated with any objects in the IP-to-object map, (iii) the extracted local IP address does not match to any IP addresses associated with any services in the public IP-to-service object map, (iv) the extracted local port number matches to a port number associated with a service in the NodePort-to-service object map, (v) the service is associated with a cluster IP address that corresponds to the particular cluster of destination workloads, and (vi) a service object associated with the service matches to a workload in the service-to-workload map.

13. The method of claim 10, wherein the data traffic flow is determined to be an ingress data traffic flow when (i) the extracted remote IP address does not match to any IP addresses associated with any objects in the IP-to-object map, (ii) the extracted local IP address does not match to any IP addresses associated with any objects in the IP-to-object map, (iii) the extracted local IP address matches to an IP address associated with a service object in the public IP-to-service object map, (iv) the service is associated with a cluster IP address that corresponds to the particular cluster of destination workloads, and (v) a service object associated with the service matches to a workload in the service-to-workload map.

14. The method of claim 1, wherein the set of services comprises (i) a load balancing service that directs ingress data traffic flows to the particular cluster of destination workloads, and (ii) a NodePort service that exposes, on ports of node machines, workloads executing on the node machines.

15. The method of claim 14, wherein the node machines comprise any of (i) virtual machines and (ii) physical host machines.

16. A non-transitory machine readable medium storing a program for execution by a set of processing units, the program for identifying and generating visualizations of ingress data traffic flows to a workload cluster in a software-defined network (SDN), the program comprising sets of instructions for:
from a plurality of data traffic flows associated with a particular cluster of destination workloads in the SDN, identifying a set of ingress data traffic flows destined to the particular cluster of destination workloads;
for each identified ingress data traffic flow, identify a service from a set of services through which the ingress data traffic flow reached the particular cluster of destination workloads; and
generating a visualization for display through a user interface (UI), the visualization comprising (i) representations of each workload in the particular cluster of destination workloads, (ii) representations of the set of services through which the set of ingress data traffic flows reach the particular cluster of destination workloads, and (iii) a representation of the set of ingress data traffic flows terminating on the particular cluster of destination workloads.

17. The non-transitory machine readable medium of claim 16, wherein the set of instructions for identifying the set of ingress data traffic flows destined to the particular cluster of destination workloads comprises sets of instructions for, for each data traffic flow in the plurality of data traffic flows:
extracting from packets belonging to the data traffic flow a remote IP (Internet protocol) address, a local IP address, and a local port number; and
using the extracted remote IP address and at least one of the extracted local IP address and the extracted local port number to query a set of maps to determine whether the data traffic flow is an ingress data traffic flow, the set of maps comprising (i) an IP-to-object map, (ii) a service-to-workload object map, (iii) a NodePort-to-service object map, and (iv) a public IP address-to-service object map.

18. The non-transitory machine readable medium of claim 17, wherein the data traffic flow is determined to be an ingress data traffic flow when (i) the extracted remote IP address does not match to any IP addresses associated with any objects in the IP-to-object map, (ii) the extracted local IP address matches to an IP address associated with a node object in the IP-to-object map, (iii) the extracted local port number matches to a port number associated with a service in the NodePort-to-service object map, (iv) the service is associated with a cluster IP address that corresponds to the particular cluster of destination workloads, and (v) a service object associated with the service matches to a workload in the service-to-workload map.

19. The non-transitory machine readable medium of claim 17, wherein the data traffic flow is determined to be an ingress data traffic flow when (i) the extracted remote IP address does not match to any IP addresses associated with any objects in the IP-to-object map, (ii) the extracted local IP address does not match to any IP addresses associated with any objects in the IP-to-object map, (iii) the extracted local IP address does not match to any IP addresses associated with any services in the public IP-to-service object map, (iv) the extracted local port number matches to a port number associated with a service in the NodePort-to-service object map, (v) the service is associated with a cluster IP address that corresponds to the particular cluster of destination workloads, and (vi) a service object associated with the service matches to a workload in the service-to-workload map.

20. The non-transitory machine readable medium of claim 17, wherein the data traffic flow is determined to be an ingress data traffic flow when (i) the extracted remote IP address does not match to any IP addresses associated with any objects in the IP-to-object map, (ii) the extracted local IP address does not match to any IP addresses associated with any objects in the IP-to-object map, (iii) the extracted local IP address matches to an IP address associated with a service object in the public IP-to-service object map, (iv) the service is associated with a cluster IP address that corresponds to the particular cluster of destination workloads, and (v) a service object associated with the service matches to a workload in the service-to-workload map.
